(19) United States
(12) Patent Application Publication
(10) Pub. No.: US 2006/0072608 A1
(43) Pub. Date: Apr. 6, 2006

(54) Communication band controller

(76) Inventors: Toui Miyawaki, Yokohama (JP); Emiko Kobayashi, Yokohama (JP); Takeshi Ishizaki, Yokohama (JP); Shigeru Miyake, Tokyo (JP); Kiminori Sugauchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/012,132

(22) Filed: Dec. 16, 2004

(30) Foreign Application Priority Data
Oct. 4, 2004 (JP) 2004-290946

(51) Int. Cl. H04J 3/16

(52) U.S. Cl. 370/468; 370/252

(57) ABSTRACT

The band controller 500 included in the computer system 1000 regularly acquires map information and IF information, etc. from the work server 100, the storage device 200, and the routers 300 and 400, and based on these pieces of information, detects iSCSI sessions for which the communication band is insufficient. When an iSCSI session with insufficient band is detected, the band controller 500 selects another iSCSI session to perform band allocation based on the iSCSI session importance level or the circuit use-rate. The band controller 500 allocates at least part of the communication band of the network route used by the iSCSI session selected in this way to the iSCSI session with insufficient band.

The computer system 1000 performs efficient data transfer in storage area networks on which many variations of communication band exist.

### CROSS-REFERENCES TO RELATED APPLICATION

The present application relates to and claims priority from Japanese application No. P2004-290946 filed on Oct. 4, 2004, the content of which is hereby incorporated by reference into this application.

### BACKGROUND OF THE INVENTION

1. Field of the Invention

The present invention relates to technology that controls communication bands between server devices and storage devices connected by a network.

2. Description of the Related Art

In the past, for the connection between server devices and storage devices, there was a great deal of use of storage area networks that use fiber channel protocol (hereafter called “FC-SAN”). With an FC-SAN, there are few types of communication bands that are supported due to the scale of the fiber channel, and it was possible for an administrator to make connections without being very conscious of the server devices or storage devices and the communication band of the network devices that connect these.

However, in recent years, the market needs are shifting from the FC-SAN to a storage area network that uses a general use internet protocol (hereafter called “IP-SAN”) (see U.S. patent No. U.S. 2004/0010605 A1). With an IP-SAN, rather than using a fiber channel for the connection between server devices and storage devices, an IP network that has a very high number of communication band variations is used. Because of this, when each device is connected as with the prior art FC-SAN, for example with a narrow band for the communication band of the server device and storage device, there were cases of band allocation mismatch occurring when viewed as the overall IP-SAN, such as cases of the communication band within the IP network between these becoming a broad band, etc.

When a mismatch of allocation for the communication band occurs as described above, there are cases when the band is insufficient for communication between the server device and storage device, and due to a dependency on narrow band circuits, there were also cases when it was not possible to effectively make use of broad band circuits. This kind of problem was not limited to IP-SAN, but was a problem also common to FC-SAN when the band types were increased as well as other storage area networks.

The present invention was created taking into consideration the problems noted above, and its purpose is to execute efficient data transfer for storage area networks on which many communication band variations exist.

Considering the purpose noted above, the key points of the band controller of the present invention are that it is a band controller that controls the communication band between a server device and a storage device connected by a network, wherein the server device establishes a plurality of sessions which are logical communication routes to the storage device via network routes that differ for each session, and comprises: a bandwidth information acquisition unit that acquires bandwidth information relating to the communication band used by the session for each of the sessions, a detection unit that detects insufficient band sessions for which the communication band is insufficient, and a band allocation unit that, for the insufficient band sessions, allocates at least part of the communication band of the network route used by another session selected based on a specified index used for allocation of band.

### SUMMARY OF THE INVENTION

With the band controller of the present invention, when the communication band of a session established between a server device and storage device is insufficient, it is possible to allocate communication band of the network route used by another session. Therefore, even for a storage area network on which a large number of communication band variations exist, it is possible to efficiently transfer data between server devices and storage devices.

For a band controller with the structure noted above, it is also possible to have the detection unit judge that the communication band of the session is insufficient when the communication band of at least part of the circuits in a network route used by the session is a communication band that is narrower than the circuits of other parts.

With this kind of structure, it is possible to allocate band to sessions for which there are parts with band mismatch on the network route.

For a band controller with this structure, it is also possible to have the band information acquisition unit further comprise a supported band information acquisition unit that acquires information relating to the communication bands supported by each device from the server devices and the storage devices and the network devices that are interposed within the network, and for the detection unit to detect circuits with the narrow communication bands based on information acquired by the supported band information acquisition unit.

It is also possible to have the band information acquisition unit further comprise an actually measured band information acquisition unit that acquires information relating to the actually measured values of the communication band for each device from the server devices and the storage devices and the network devices that are interposed in the network, and to have the detection unit detect circuits of the narrow communication band based on the information acquired by the actually measured band information acquisition unit.

With this kind of structure, it is possible to easily detect sessions for which the communication band is insufficient. Note that it is also possible to detect circuits with narrow communication band based on both the communication bands supported by each device and the actually measured values of the communication band.

For a band controller of the structure noted above, it is also possible to have the detection unit comprise a means of notifying the administrator of information relating to the insufficient band sessions when the insufficient band sessions are detected.

With this kind of structure, it is easy for the administrator to judge whether or not to perform communication band allocation. The information relating to insufficient band sessions can be, for example, information displayed on a monitor, or can be notified by voice.

For the band controller of the structure noted above, it is possible to have the specified index noted above indicates importance preset for each of the sessions, for the band information to include information that shows this importance, and for the band allocation unit to has a means of selecting another of the sessions based on the information. Or, it is also possible to have the specified index noted above be the use-rate of the network route used by each of the sessions, to include information that shows this use-rate in the band information, and to have the band allocation unit comprise a means of selecting another of the sessions based on this use-rate.

With this kind of structure, for example, it is possible to allocate the communication band of sessions with low importance or sessions with a low use-rate to sessions for which the band is insufficient.

For the band controller of the structure noted above, it is also possible to have the sessions be established between the application executed by the server device and the logical volume within the storage device that is the access point of that application, and for the band allocation unit to comprise a means of switching the access point of another session to the access point of the insufficient band session when allocating communication band to the insufficient band session.

With this kind of structure, it is possible to have the sessions that receive band allocation access the same logical volume as before allocation using the newly allocated communication band.

Note that for the present invention, in addition to the structures as the band controller described above, it is also possible to use a structure, for example, of a band control method or a computer program that controls communication band between the server devices and storage devices connected by a network. This computer program can be realized within a carrier wave as data signals, or can be recorded on a recording medium that can be read by a computer. As the recording medium, it is possible to use a CD-ROM, flexible disk, photo magnetic disk, or DVD, etc.

### BRIEF DESCRIPTION OF THE DRAWINGS

FIG. 1 is an explanatory diagram that shows the hardware structure of the computer system 1000.

FIG. 2 is an explanatory diagram that shows the logical structure of the computer system 1000.

FIG. 3 is an explanatory diagram that shows an example of the application table AT.

FIG. 4 is an explanatory diagram that shows an example of a port table PT.

FIG. 5 is an explanatory diagram that shows an example of a default gateway table GT.

FIG. 6 is an explanatory diagram that shows an example of an iSCSI session table ST.

FIG. 7 is an explanatory diagram that shows an example of a band table BT.

FIG. 8 is an explanatory diagram that shows an example of a route table RT.

FIG. 9 is an explanatory diagram that shows an example of a band management table MT.

FIG. 10 is a flow chart of the band control processing routine.

FIG. 11 is an explanatory diagram that shows an example of the notice that is displayed on the monitor 550.

FIG. 12 is a flow chart of the process executed by the iSCSI driver.

### DESCRIPTION OF THE PREFERRED-EMBODIMENTS

Following, we will explain in the following sequence embodiments of the present invention based on working examples.
A. Overall Structure of the Computer System:
B. Various Tables Managed by the Band Controller:
C. Process Executed by the Band Controller:
D. Process Executed by the Work Server and Storage Device:

A. Overall Structure of the Computer System:

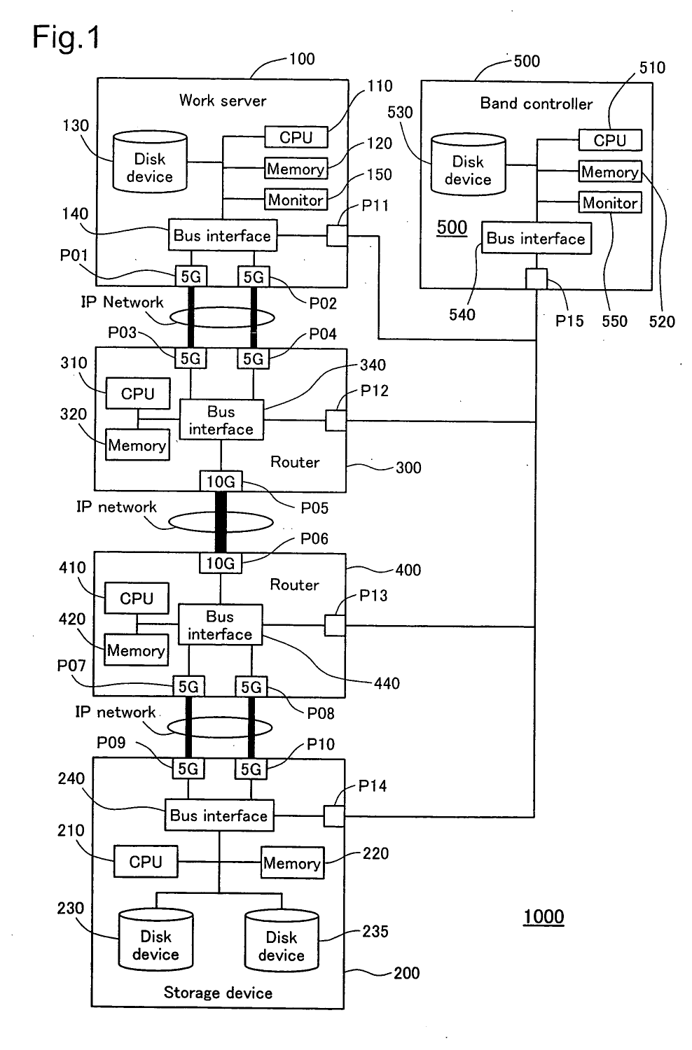

FIG. 1 is an explanatory diagram that shows the hardware structure of the computer system 1000 that contains a band controller 500 as a working example. As shown in the fig., the computer system 1000 consists of a work server 100, a storage device 200, a router 300, a router 400, and a band controller 500. The work server 100 and the storage device 200 are connected by an IP-SAN via two routers 300 and 400.

The work server 100 is a general purpose computer that executes various work applications, and comprises a CPU 110, a memory 120, a disk device 130, a bus interface 140, a monitor 150, and three physical ports P01, P02, and P11. The physical port P01 and physical port P02 respectively support 5 Gbps communication bands, and are connected via an IP network to the physical ports P03 and P04 of the router 300. Also, the physical port P11 is connected to the physical port P15 of the band controller 500 via a specified communication circuit.

The router 300 is a network relay device that transfers received network packets to the optimal route according to its destination, and comprises a CPU 310, a memory 320, a bus interface 340, and four physical ports P03, P04, P05, and P12. Of the four physical ports, the physical port P03 and the physical port P04 each respectively support a 5 Gbps communication band, and are connected to the physical ports P01 and P02 of the work server 100 via an IP network. In contrast to this, the physical port P05 supports a 10 Gbps communication band, and is connected to the physical port P06 of the router 400 via an IP network. Also, the physical port P12 is connected to the physical port P15 of the band controller 500 via a specified communication circuit.

Like with the router 300, the router 400 also comprises a CPU 410, a memory 420, a bus interface 440, and four physical ports P06, P07, P08, and P13. Of these, the physical port P06 supports a 10 Gbps communication band, and is connected to the physical port P05 of the router 300 via an IP network. In contrast to this, the physical ports P07 and P08 respectively support 5 Gbps communication bands, and are connected to the physical ports P09 and P10 of the storage device 200 via an IP network. Also, the physical port P13 is connected to the physical port P15 of the band controller 500 via a specified communication circuit.

The storage device 200 is a device for storing data transferred from the work server 100 via an IP network, and it comprises a CPU 210, a memory 220, a large capacity disk device 230 and 235, a bus interface 240, and three physical ports P09, P10, and P14. Of the three physical ports, the physical ports P09 and P10 respectively support 5 Gbps communication bands, and are connected to the physical ports P07 and P08 of the router 400 via an IP network. Also, the physical port P14 is connected to the physical port P15 of the band controller 500 via a specified communication circuit.

The band controller 500 is a general purpose computer that comprises a CPU 510, a memory 520, a disk device 530, a bus interface 540, a monitor 550, and a physical port P15, and is a device for controlling the communication band of iSCSI sessions that are established between the work server 100 and the storage device 200. The physical port P15 is connected to all devices described above via a specified communication circuit such as an IP network, an RS-232C, or a public circuit network, etc.

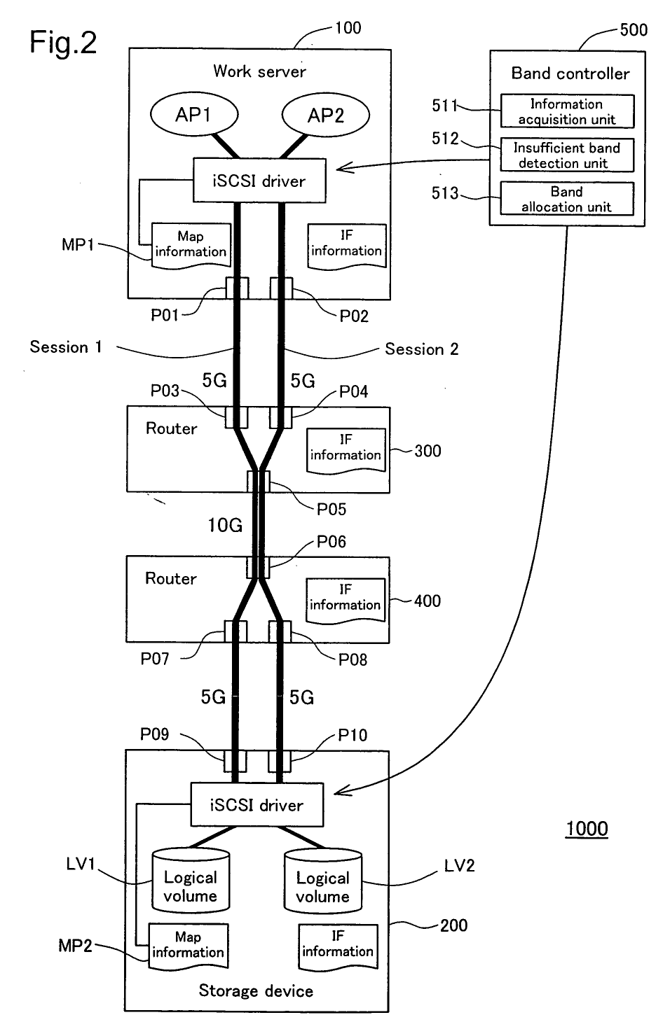

FIG. 2 is an explanatory diagram that shows the logical structure of the computer system 1000. An operating system in which the iSCSI driver is incorporated or an application AP1 or AP2 are installed in the disk device 130 of the work server 100, and the CPU 110 executes these programs. The iSCSI driver is a program for exchanging SCSI commands between other devices connected by an IP network. The iSCSI driver is executed for the storage device 200 as well, and each application uses these iSCSI drivers to establish iSCSI sessions between the logical volumes LV1 and LV2 secured within the storage device 200.

With this working example, the application AP1 establishes an iSCSI session called “session 1” between the logical volume LV1 within the storage device 200. Also, the application AP2 establishes an iSCSI session called “session 2” between the logical volume LV2. The data that is sent and received by the session 1 flows within a network route formed by the physical port P01, the physical port P03, the physical port P05, the physical port P06, the physical port P07, and the physical port P09. Also, the data that is sent and received by the session 2 flows within a network route formed by the physical port P02, the physical port P04, the physical port P05, the physical port P06, the physical port P08, and the physical port P10. Specifically, each of the iSCSI sessions are established via a different network route between the work server 100 and the storage device 200. Note that for the two network routes, if all of the routes are not completely matched, even if part overlaps, it can be said that the two network routes are different.

The iSCSI drivers of the work server 100 and the storage device 200 respectively manage the map information that defines the relationship between the iSCSI session and the physical port that is used by that session. For example, in the map information MP1 managed by the work server 100, it is defined that the session 1 uses the physical port P01 and the session 2 uses the physical port P02. Also, it is defined in the map information MP2 that is managed by the storage device 200 that the session 1 uses the physical port P09 and the session 2 uses the physical port P10. This map information is stored in the memory of each device or inside a disk device.

The work server 100, the storage device 200, and the routers 300 and 400 hold the interface (F) information in the memory of each or within the disk device. The IF information is information that relates to the network interface on which the physical port is mounted, and contains information such as the number of physical ports, the physical port number, the maximum communication band supported by that physical port, the current circuit use-rate, and the physical port link status (up/down), etc. Each device, by executing the internal program, always monitors these pieces of information, and updates the IF information.

Installed inside the disk device 530 of the band controller 500 is a program for adjusting the communication band of each of the iSCSI sessions established between the work server 100 and the storage device 200. The CPU 510 functions as the illustrated information acquisition unit 511, the insufficient band detection unit 512, and the band allocation unit 513 by executing this program.

By using the SNMP protocol, the information acquisition unit 511 has a function of acquiring from the work server 100, the storage device 200, and the routers 300 and 400 the respective map information and IF information and default gateway definition information, etc. The insufficient band detection unit 512 has a function of detecting whether or not insufficient band has occurred for each iSCSI session based on the various pieces of information acquired in this way. The band allocation unit 513 has a function of allocating the communication band of the network route used by another iSCSI session to an iSCSI session for which a band insufficiency has occurred by giving an instruction to each iSCSI driver.

B. Various Tables Managed by the Band Controller:

Next, we will explain the various tables that are generated and managed based on information acquired from each device by the band controller 500. Each of the tables shown below is stored in the memory 520 of the band controller 500 or the disk device 530.

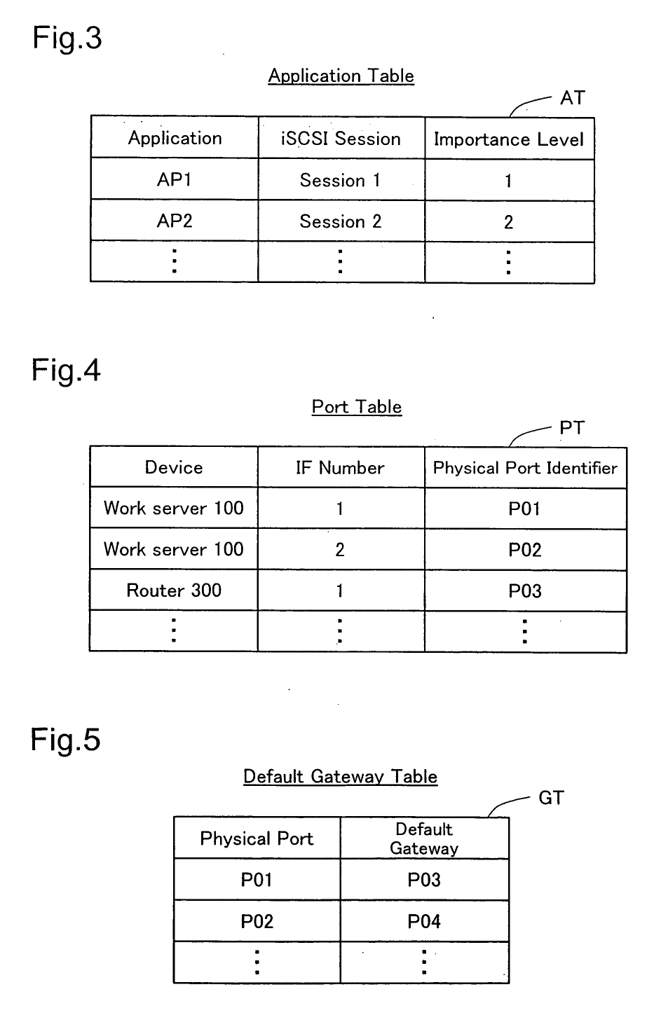

FIG. 3 is an explanatory diagram that shows an example of the application table AT. The band controller 500 regularly acquires from the iSCSI driver of the work server 100 and the storage device 200 information that shows the relationship between the application and the iSCSI session, and information that shows the level of importance of the application or the iSCSI session. Then, based on these pieces of information, the application table AT that is illustrated is generated automatically. The importance level is a parameter that is preset by the administrator using the work server 100 or the band controller 500. With this working example, the lower the numeric value of the importance level, the higher the importance level of the application or the iSCSI session that is shown. Note that for the importance level, it is possible to have, for example, the work server 100 count the activation frequency for each application, and to automatically set the highest activation frequency as the highest importance level.

FIG. 4 is an explanatory diagram that shows an example of a port table PT. The band controller 500 automatically allocates an individual physical port identifier to the network interface equipped in each device. Then, based on this information, the illustrated port table PT is generated. Of course, this physical port identifier may also be input and allocated by the administrator.

FIG. 5 is an explanatory diagram that shows an example of a default gateway table GT. The band controller 500 regularly acquires from the iSCSI driver of the work server 100 and the storage device 200 information relating to the router physical port allocated as a default gateway for the physical ports of the work server 100 and the storage device 200. Then, based on these pieces of information, the illustrated default gateway table GT is generated. Note that with this working example, the default gateway is shown by the physical port identifier, but it is also possible to show this using an IP address that corresponds to that physical port.

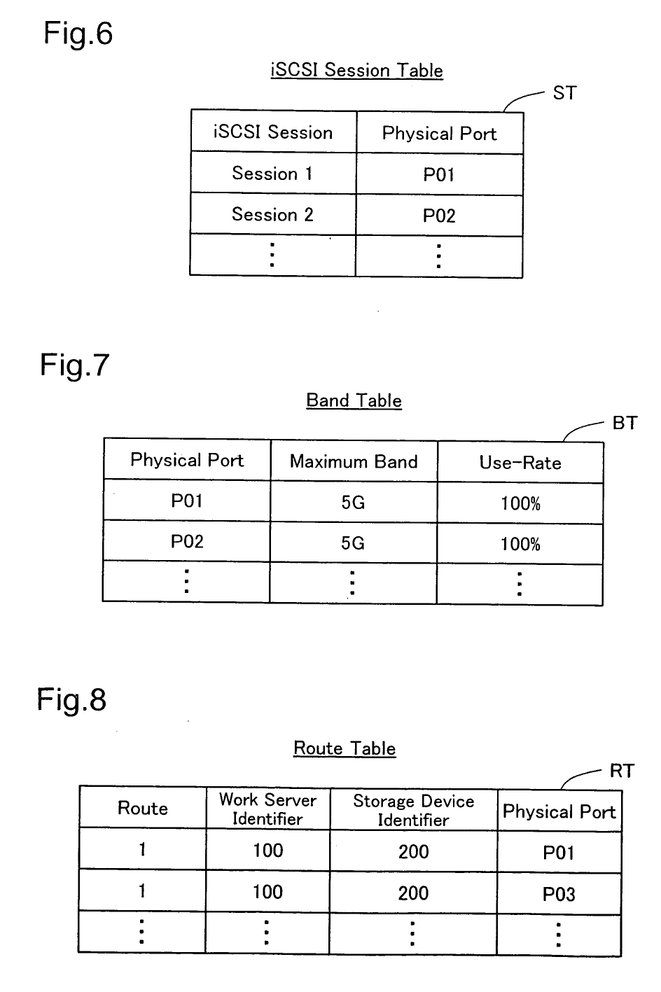

FIG. 6 is an explanatory diagram that shows an example of the iSCSI session table ST. The band controller 500 regularly acquires from the iSCSI drivers of the work server 100 and the storage device 200 information that shows the relationship between the iSCSI session and the physical port that the iSCSI session uses, and the illustrated iSCSI session table ST is automatically generated.

FIG. 7 is an explanatory diagram that shows an example of a band table BT. The band controller 500 regularly acquires from the work server 100 and the storage device 100 and the router 300 and router 400 the IF information respectively held by each device. As described above, the IF information includes mainly information such as the physical port identifier, the maximum communication band supported by that physical port, and the current use-rate of that physical port, etc. The band controller 500 automatically generates the illustrated band table BT based on this IF information.

FIG. 8 is an explanatory diagram that shows an example of a route table RT. The band controller 500 regularly acquires from each router the routing information, and the illustrated route table RT is automatically generated based on this information. This route table RT shows which work server and which storage device the network route is established between, and which physical ports that route consists of.

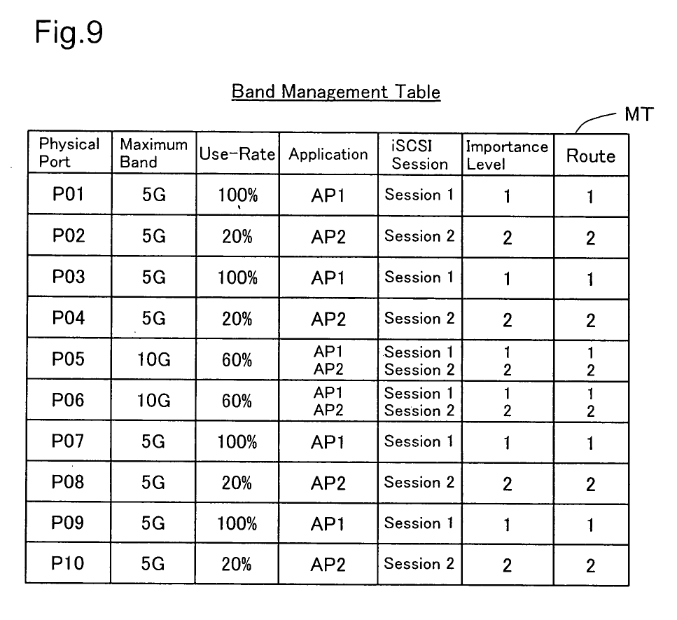

FIG. 9 is an explanatory diagram that shows an example of a band management table MT. The band controller 500 creates the application table AT, the port table PT, the default gateway table GT, the iSCSI session table ST, the band table BT, and the route table RT, after which it automatically generates the illustrated band management table MT based on these tables in order to comprehensively manage the circuits within the computer system 1000.

C. Process Executed by the Band Controller:

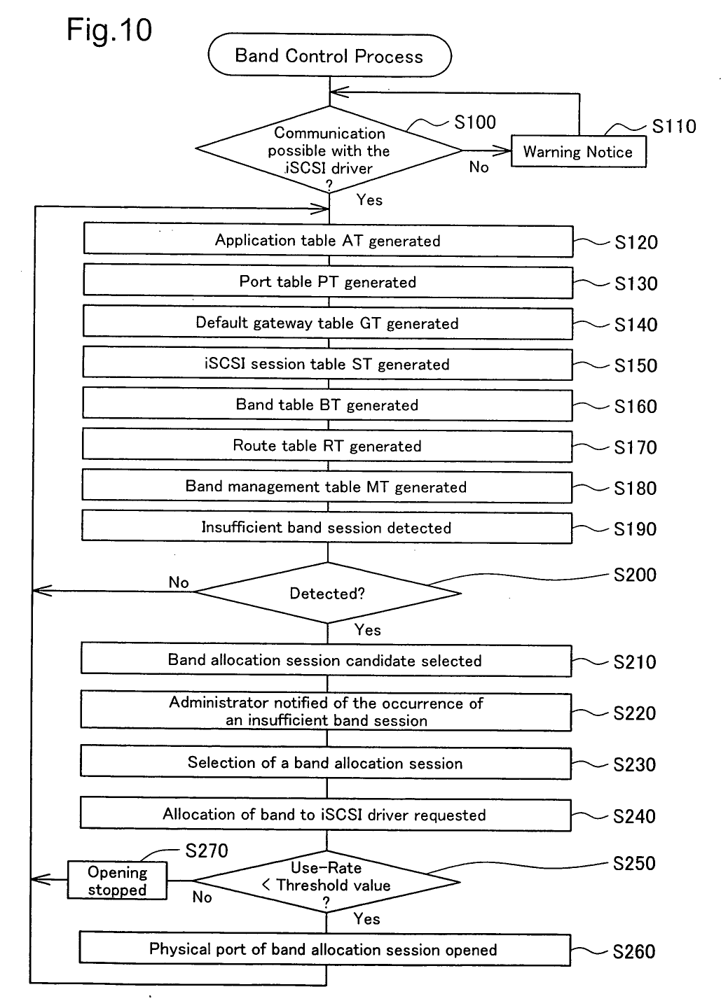

FIG. 10 is a flow chart of a band control process routine always executed by the band controller 500 to adjust the communication band of each iSCSI session. At the beginning, the band controller 500 performs communication with the iSCSI drivers that all the servers and storage devices that exist in the computer system 1000 have, and confirms that normal communication can be performed (step S100). If communication is not possible, it notifies the administrator of a warning to this effect by making a specified display on the monitor 550 (step S110), and if communication is possible, advances to the subsequent step.

The band controller 500 acquires from the iSCSI driver that the work server 100 and the storage device 200 have information that shows the relationship between the application and the iSCSI session, and also acquires information that shows the importance level of applications or iSCSI sessions set in advance by the administrator. At this time, when it is not possible to acquire the information that shows the importance level, it is also possible to make a notification to the administrator to urge setting of the importance level. Then, the band controller 500 generates the application table AT shown in FIG. 3 based on these pieces of information (step S120).

Next, the band controller 500 generates the port table PT shown in FIG. 4 (step S130). Then, it acquires the default gateway information from the work server 100 and the storage device 200 and generates the default gateway table GT shown in FIG. 5 (step S140). Next, map information for which the relationship between the iSCSI sessions and physical ports is defined is acquired from each iSCSI driver, and based on this map information, the iSCSI session table ST shown in FIG. 6 is generated (step S150).

Furthermore, the band controller 500 acquires IF information from all the devices within the computer system 1000, and based on this IF information, generates the band table BT shown in FIG. 7 (step S160). Then, routing information is acquired from the routers 300 and 400, and the routing table shown in FIG. 8 is generated (step S170).

The band controller 500 generates the band management table MT shown in FIG. 9 based on information of the application table AT, the port table PT, the default gateway table GT, the iSCSI session table ST, the band table BT, and the routing table RT which were generated with the processing up to this point (step S180).

Next, the band controller 500 detects an iSCSI session for which the communication band is insufficient (hereafter called an “insufficient band session”) based on the band management table MT generated with step S180 noted above (step S190). Whether or not the communication band is insufficient is determined as follows. Specifically, for the network route on which the iSCSI session is established, when there are circuit parts for which there is a band difference (gap) greater than a specified threshold value (e.g. 3 Gbps) with another circuit band, in other words, when there is a circuit part that becomes a bottleneck, and furthermore, the use-rate of the circuit that is a bottleneck is greater than a specified threshold value (e.g. 80%, etc.), that iSCSI session is judged to have insufficient band. For example, with the band management table MT shown in FIG. 9, the network route 1 on which the session 1 is established in contrast to the fact that the band between the physical ports P05 and P06 is 10 Gbps, the band between physical ports P01 to P03 is 5 Gbps, so we can say that the circuit between the physical ports P01 to P03 is a bottleneck. Also, from the fact that the use-rate of this circuit is 100%, the communication band of the session 1 is judged as being insufficient. Note that when finding the band gap, it is possible to find the gap based on the maximum communication band supported by each device, or to find the gap based on the actually measured value of the communication band.

As a result of the detection of step S190 noted above, when an insufficient band session is not detected (step S200: No), the process returns to the aforementioned step S120. Meanwhile, when an insufficient band session is detected (step S200: Yes), for this insufficient band session, a candidate is selected to be an iSCSI session that performs communication band allocation (hereafter called a “band allocation session”) (step S210). With this process, of the iSCSI sessions which have an importance level or circuit use-rate that is lower than the insufficient band session, an iSCSI session which can access the same logical volume as the access point of the insufficient band session, in other words, an iSCSI session that accesses the same storage device as the insufficient band session, is selected.

Next, the band controller 500 notifies the administrator by making a display on the monitor 550 to the effect that an insufficient band session has occurred (step S220). Note that this notification may also be made by voice.

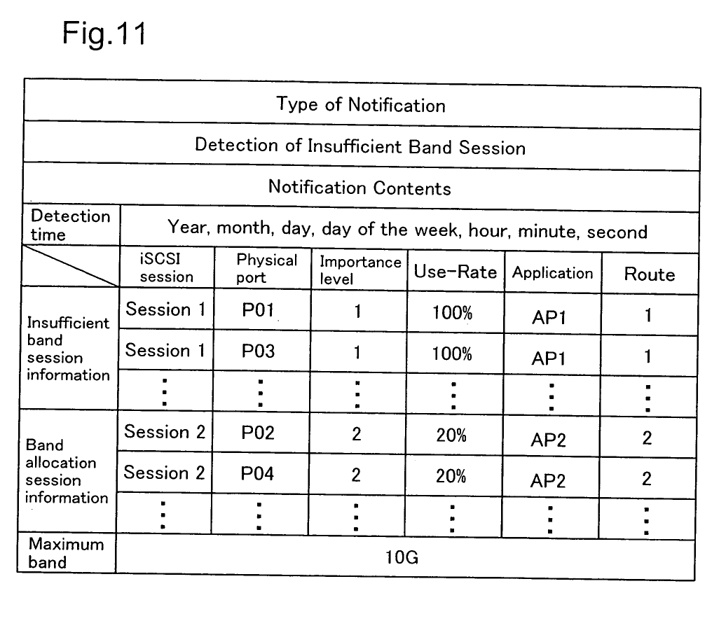

FIG. 11 is an explanatory diagram that shows an example of the notice displayed on the monitor 550. As shown in the fig., this screen is roughly divided into a section for displaying the type of notification contents and a section for displaying those notification contents. In the notification type section, a message that says “insufficient band session detected” is displayed, and in the notification contents section, the date and time the insufficient band session was detected, information relating to the insufficient band session, information relating to the band allocation session, and a maximum band that shows how big an overall area can be secured are displayed. Note that when there are multiple candidates for band allocation sessions, it is preferable to display these in sequence of low importance level and use-rate for that session. Note that in this screen, it is possible to display not just information relating to the insufficient band session, but also a variety of information such as information relating to the communication status with the iSCSI driver and information relating to the definition of the iSCSI session importance level, etc.

We will return to FIG. 10 for our explanation. After the step S220 noted above, the band controller 500 selects an iSCSI session to perform actual band allocation by having the administrator select from the candidate band allocation sessions displayed on the monitor 550 or by automatically making a selection according to the importance level or circuit use-rate (step S230). Then, the identifiers of the insufficient band session and the band allocation session are notified to the iSCSI drivers of the work server 100 and the storage device 200, and a request is made to allocate communication band of the network route used by the band allocation session to the insufficient band session (step S240). At this time, the allocated circuit capacity is determined according to the band allocation session importance level or circuit use-rate, and it is also possible to notify the iSCSI driver of this allocation capacity.

Next, the band controller 500 judges whether or not the use-rate of the physical port on the network route used by the band allocation session is lower than a threshold value preset by the administrator (e.g. 70%) (step S250). When lower than the threshold value, the physical port used by the band allocation session is opened to the insufficient band session (step S260), and when it is over the threshold value, opening is stopped (step S270). Note that with this process, rather than the physical port use-rate, it is possible to set as the threshold value, for example, the time that a band allocation session is able to occupy a physical port with its own communication. In this case, when the threshold value is exceeded, the physical port is opened to the insufficient band session. The band controller 500 repeatedly executes the band control process routine explained above.

D. Process Executed by the Work Server and Storage Device:

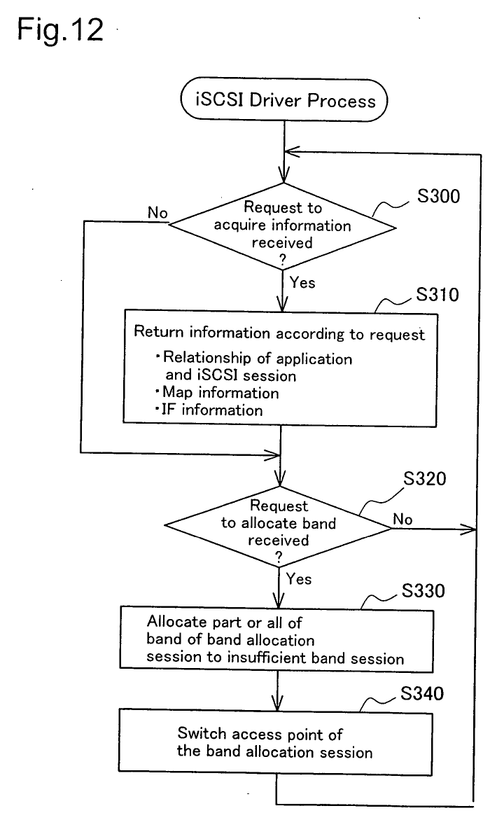

FIG. 12 is a flow chart of the process always executed by the iSCSI driver of the work server 100 and the storage device 200. When the work server 100 and the storage device 200 receive a request to acquire information from the band controller 500 (step S300), according to the type of information requested, information such as information that shows the relationship between the application and the iSCSI session, map information, and IF information, etc. is returned (step S310).

Next, when the work server 100 and the storage device 100 receive a request for band allocation from the band controller 500 (step S320), part or all of the network route used by the band allocation session is allocated to the insufficient band session (step S330). When there is a specification of the circuit capacity allocated from the band controller 500, band is allocated according to that specification. Then, the access point of the band allocation session is switched to the access point of the insufficient band session (step S340). At this time, if security settings such as LUN masking processing are required, the work server 100 and the storage device 200 perform these together. The work server 100 and the storage device 200 repeatedly execute the process explained above.

With the band controller 500 and the computer system 1000 of this working example constructed as described above, even if there is a part for which the communication band does not match within the IP network, it is possible to dynamically allocate the communication band of the network route used by another iSCSI session to an iSCSI session for which the communication band is insufficient. Therefore, it is possible to make effective use of broad band circuits within an IP network, and also to increase the overall processing capability of the computer system 1000, and to perform effective transfer of data. Also, the server device 100 and the storage device 200 may perform band adjustment for each session according to instructions from the band controller 500, and since it is not necessary to perform complicated processing for band adjustment, it is possible to attempt to make suitable the processing share for the overall computer system 1000.

Above, we explained a working example of the present invention, but the present invention is not limited to the working examples, and it goes without saying that a variety of embodiments may be implemented in a scope that does not stray from the key points of the present invention. For example, the selection of the band allocation session was performed based on the iSCSI session importance level and the physical port use-rate, but it is also possible to make a selection based on other parameters.

Also, with the working examples noted above, we assumed a case when the session 1 and the session 2 both have 5 Gbps of communication band between the work server 100 and the router 300, but for actual operation, there does not necessarily have to be equivalent band design. Therefore, when selecting a band allocation session, rather than judging simply based on whether or not that iSCSI session can access the target logical volume, the band controller 500 can also select an iSCSI session that has a more suitable band from among multiple iSCSI session candidates.

Also, with the working examples noted above, examples were listed of cases when there is broad band within the IP network, but it is also possible to have a case of narrow band within the IP network while there is broad band on the work server 100 side and the storage device 200 side. In such a case, it is also possible to have the circuit that is a bottleneck within the IP network be detected automatically, and to secure the band required for this, to dynamically change the physical port within the IP network by giving specified commands to the routers 300 and 400. It is possible to change the allocation of the physical port by accessing the routers, for example, using a protocol such as TELNET, HTTP, or SNMP, or using a router specific protocol, or by changing the device setting (configuration), etc.

Also, with the working examples noted above, the band controller 500 was explained as being an independent device, but it is also possible to have it incorporated within the work server 100, the storage device 200, or the routers 300 or 400. Also, with the working examples noted above, the work server 100 and the storage device 200 are connected by an IP-SAN, but it is also possible to connect them by an FC-SAN.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A band controller that controls the communication band between a server device and a storage device connected via a network,
wherein the server device establishes a plurality of sessions, that are the logical communication path to the storage device, via a different network route for each session,
wherein the band controller comprises:
a band information acquisition unit that acquires band information relating to the communication band used by the session for each of the sessions;
a detection unit that detects insufficient band sessions for which the communication band is insufficient, based on the band information; and
an allocation function realization unit that allocates at least part of the communication band of the network path used by another session selected based on a specified index used for band allocation to the insufficient band session.

2. A band controller in accordance with claim 1, wherein
the detection unit judges that the session communication band is insufficient in cases when the communication band of at least part of the circuit within the network route used by the session is a narrower communication band than circuits of the other parts.

3. A band controller in accordance with claim 2, further comprising
a means that reports information to the administrator, the information relating to the insufficient band session when the detection unit detects the insufficient band session.

4. A band controller in accordance with claim 1, wherein
the specified index indicates importance preset for each of the sessions;
the band information includes information corresponding to the importance; and
the band allocation unit has a means of selecting another of the sessions based on the information.

5. A band controller in accordance with claim 1, wherein
the specified index is a use-rate of the network route used by each of the sessions;
the band information includes the use-rate; and
the band allocation unit has a means that selects another of the sessions based on the use-rate.

6. A band controller in accordance with claim 1, wherein
the sessions are established between an application executed by the server device and a logical volume within the storage device that is the access point of the application, and
the band allocation unit has a means of switching the access point of another session to the access point of the insufficient band session when the band allocation unit allocates communication band to the insufficient band session.

7. A band controller in accordance with claim 2, wherein
the band information acquisition unit further has a supported band information acquisition unit that acquires information relating to the communication bands supported by each device from the server device, the storage device, and the network devices interposed in the network; and
the detection unit detects circuits with a narrower communication band based on the information acquired by this supported band information acquisition unit.

8. A band controller in accordance with claim 7, further comprising:
a reporting unit that reports to the administrator information relating to the insufficient band session when the detection means detects an insufficient band session.

9. A band controller in accordance with claim 7, wherein
the specified index indicates importance preset for each of the sessions;
the band information includes information corresponding to the importance; and
the band allocation unit has a means of selecting another of the sessions based on the information.

10. A band controller in accordance with claim 7, wherein
the specified index is a use-rate of the network route used by each of the sessions;
the band information includes the use-rate; and
the band allocation unit has a means that selects another of the sessions based on this use-rate.

11. A band controller in accordance with claim 7, wherein
the sessions are established between an application executed by the server device and a logical volume within the storage device that is the access point of the application, and
the band allocation unit has a means of switching the access point of another session to the access point of the insufficient band session when allocating communication band to the insufficient band session.

12. A band controller in accordance with claim 2, wherein
the band information acquisition unit has an actual measurement band information acquisition unit that acquires information relating to the actual measured values of the communication band for each device from the server device, the storage device, and the network devices interposed in the network; and
the detection unit detects circuits with a narrower communication band based on the information acquired by the actual measurement band information acquisition unit.

13. A band controller in accordance with claim 12, further comprising:
a reporting unit that reports to the administrator information relating to the insufficient band session when the detection unit detects the insufficient band session.

14. A band controller in accordance with claim 13, wherein
the specified index indicates importance preset for each of the sessions;
the band information includes information corresponding to the importance; and
the band allocation unit has a means of selecting another of the sessions based on the information.

15. A band controller in accordance with claim 13, wherein
the specified index is a use-rate of the network route used by each of the sessions;
the band information includes the use-rate; and
the band allocation unit has a means of selecting another of the sessions based on the use-rate.

16. A band controller in accordance with claim 13, wherein
the sessions are established between an application executed by the server device and a logical volume within the storage device that is the access point of the application, and
the function of allocating the communication band has a means of switching the access point of another session to the access point of the insufficient band session when allocating communication band to the insufficient band session.

17. A band control method that controls a communication band between a server device and a storage device connected via a network, the method comprising:
establishing a plurality of sessions which are a logical communication paths between the server device and the storage device via a different network route for each session;
acquiring band information relating to the communication band used by each session for each of the sessions;
detecting insufficient band sessions for which the communication band is insufficient, based on the band information; and
allocating at least part of the communication band of the network route used by another session selected based on a specified index used for band allocation to the insufficient band session.

18. A computer program product for controlling communication band between a server device and a storage device connected by a network, wherein
the computer program product consists of a program code and a recording medium that records the program code,
the program code comprising:
a first program code by which establishes a plurality of sessions which are the logical communication path between the server device and the storage device via a different network route for each session;
a second program code by which band information relating to the communication band used by the session is acquired for each of the sessions;
a third program code by which insufficient band sessions for which communication band is insufficient are detected based on the band information; and
a fourth program code that allocates at least part of the communication band of the network route used by another session selected based on the specified index used for band allocation to the insufficient band session.
